(19) United States
(12) Patent Application Publication
(10) Pub. No.: US 2019/0057045 A1
(43) Pub. Date: Feb. 21, 2019

(54) METHODS AND SYSTEMS FOR CACHING BASED ON SERVICE LEVEL AGREEMENT

(71) Applicant: ALIBABA GROUP HOLDING LIMITED, George Town (KY)

(72) Inventors: Xiaowei JIANG, San Mateo, CA (US); Shu LI, Santa Clara, CA (US)

(73) Assignee: ALIBABA GROUP HOLDING LIMITED

(21) Appl. No.: 15/679,088

(22) Filed: Aug. 16, 2017

(51) Int. Cl. G06F 12/14; G06F 12/0846; G06F 12/0811; G06F 12/0866

(52) U.S. Cl. CPC G06F 12/1491; G06F 12/0846; G06F 12/0811; G06F 12/0866; G06F 2212/1052; G06F 2212/283; G06F 2212/224; G06F 2212/314; G06F 2212/621

(57) ABSTRACT

A computer system of a service provider includes a processing unit executing a thread issued by a user and a random access memory (RAM) cache disposed external to the processing unit and operatively coupled to the processing unit to store data accessed or to be accessed by the processing unit. The processing unit includes control circuitry configured to, in response to receiving an access request while the thread is being executed, determine whether the thread is allowed to access the RAM cache according to a service level agreement (SLA) level established between the service provider and the user, and when the thread is RAM cacheable, access the RAM cache.

### TECHNICAL FIELD

The present disclosure generally relates to the field of computer architecture and, more particularly, to a method and a system for caching based on service level agreement.

### BACKGROUND

Today's commercial processors (e.g., central processing unit (CPU)) are integrating more and more large cores on a single die to support workloads that demand high compute density as well as high thread-level parallelism. Nevertheless, the CPUs are facing a memory bandwidth wall. The amount of memory bandwidth required to support the memory traffic produced from the ever-growing CPU core cannot keep up with the pace that CPU cores are growing at. One way to reduce the memory traffic is to integrate large embedded caches into the CPU. Incorporating large DRAM caches raises a series of practical design issues and thus making large embedded caches an expensive device to manage.

### SUMMARY

Embodiments of the present disclosure provide a computer system of a service provider. The computer system includes a processing unit executing a thread issued by a user, and a random access memory (RAM) cache disposed external to the processing unit and operatively coupled to the processing unit to store data accessed or to be accessed by the processing unit. The processing unit includes control circuitry configured to, in response to receiving an access request while the thread is being executed, determine whether the thread is allowed to access the RAM cache according to a service level agreement (SLA) level established between the service provider and the user, and when the thread is RAM cacheable, access the RAM cache

Embodiments of the present disclosure also provide a method for operating a system kernel in a computer system of a service provider. The computer system including a processing unit and a random access memory (RAM) cache external to the processing unit and operatively coupled to the processing unit. The method includes: receiving a thread issued by a user, retrieving a service-level agreement (SLA) level established between the service provider and the user, and determining, based on the SLA level, whether the thread is allowed to assess the RAM cache.

Embodiments of the present disclosure further provide a method for operating a processing unit in a computer system of a service provider, the computer system including a random access memory (RAM) cache external to the processing unit and operatively coupled to the processing unit. The method includes receiving an access request while a thread issued by a user is being executed, determining whether the thread is allowed to access the RAM cache according to a service-level agreement (SLA) level established between the service provider and the user, and when the thread is RAM cacheable, accessing the RAM cache.

### BRIEF DESCRIPTION OF THE DRAWINGS

FIG. 1(a) and FIG. 1(b) schematically illustrate exemplary configurations of a CPU chip.

FIG. 2 schematically illustrates an exemplary processing system.

FIG. 3 is flow chart of an exemplary process for memory access in an exemplary processing system.

FIG. 4 schematically illustrates an exemplary processing system.

FIG. 5 is flow chart of an exemplary process for memory access in a processing system.

FIG. 6 schematically illustrates a processing system, consistent with the disclosed embodiments.

FIG. 7 illustrates an exemplary table defining several levels of SLA provided by a service provider to a user.

FIG. 8 is a flow chart of an exemplary process for thread allocation in an exemplary processing system, consistent with the disclosed embodiments.

FIG. 9 is a flow chart of an exemplary process for thread execution in an exemplary processing system, consistent with the disclosed embodiments.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Today's commercial processors (e.g., central processing unit (CPU)) are integrating more and more large cores on a single die to support workloads that demand high compute density as well as high thread-level parallelism. Nevertheless, the amount of memory bandwidth provided in a server is always limited by the pin count on a CPU chip in the server, which is growing at a much lower pace. Providing sufficient memory bandwidth to keep all the cores or threads running smoothly remains a significant challenge in these multi-core architectures.

One way to address the memory bandwidth issue is to integrate large embedded random access memory (RAM) caches on the CPU chip. The RAM cache can be one of a dynamic random access memory (DRAM) cache, a magnetoresistive random access memory (MRAM) cache, a resistive random access memory (ReRAM) cache, a phase change random access memory (PCRAM) cache, and a ferroelectric random access memory (FeRAM) cache. In the following descriptions, a DRAM cache is used as an example. Compared to static random access memories (SRAMs) and register files (RFs) that conventional CPU caches are built upon, DRAMs have much higher density and thus can provide caches with larger storage capacity. DRAM caches can be resided on its own die, and connected to a CPU die to form a CPU chip.

The embodiments described herein disclose an approach to mitigate the hardware design complexity associated with, for example, the DRAM cache. DRAM-cache access is granted only to service-level agreement (SLA) defined applications, allowing them to enjoy the benefit of DRAM caches, while still restrict the memory bandwidth usage at a sustainable level.

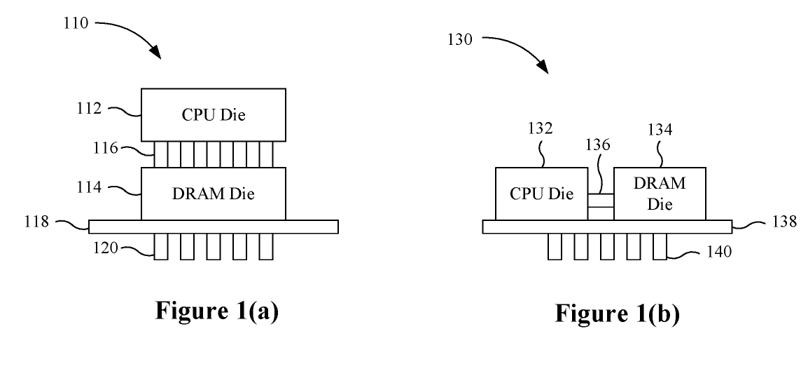

FIG. 1(a) schematically illustrates an exemplary CPU chip 110 having a three-dimensional (3D) stacking configuration. In CPU chip 110, a CPU die 112 is vertically stacked onto a DRAM die 114. CPU die 112 and DRAM die 114 are coupled to each other via a plurality of through-silicon vias 116. The stack of CPU die 112 and DRAM die 114 are disposed on a substrate 118 having a plurality of pins 120 to be coupled to an external device (not shown).

FIG. 1(b) schematically illustrates an exemplary CPU chip 130 having a Multi-Chip Packaging (MCP) structure. In CPU chip 130, a CPU die 132 and a DRAM die 134 are disposed side-by-side on a substrate 138. CPU die 132 and DRAM die 134 are coupled to each other via a plurality of MCP links 136. Substrate 138 has a plurality of pins 140 to be coupled to an external device (not shown).

Integrating DRAM caches on a CPU chip may impact the CPU design. To understand how integrating DRAM caches on a CPU chip may impact the CPU design, a conventional method for accessing memory by a CPU chip will be described first.

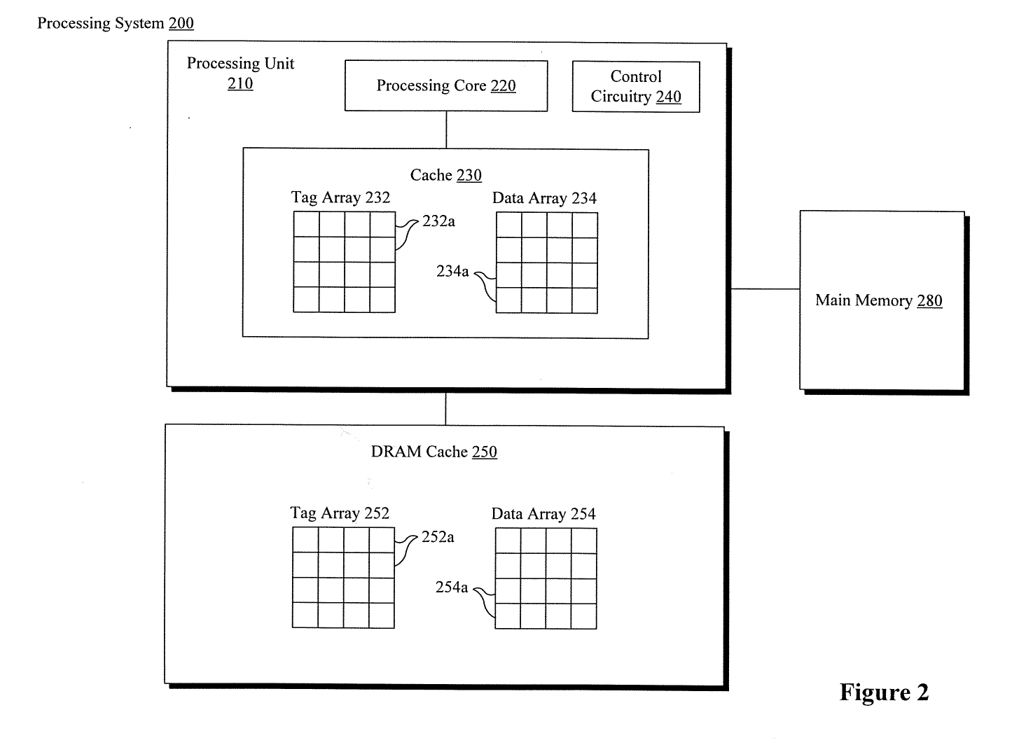

FIG. 2 schematically illustrates an exemplary processing system 200. Processing system 200 includes a processing unit 210 and a DRAM cache 250 coupled with each other. Processing unit 210 and DRAM cache 250 can be included in a CPU chip (e.g., CPU chip 110 or 130) in which processing unit 210 is disposed on a CPU die (e.g., CPU die 112 or 132), and DRAM cache 250 is disposed on a DRAM die (e.g., DRAM die 114 or 134) physically separated from the CPU die.

Processing unit 210 includes a processing core 220 and a cache 230 coupled with each other, and control circuitry 240 that controls the operation of processing unit 210. Processing unit 210 is also coupled to a main memory 280 that can store data to be accessed by processing core 220. Cache 230 and DRAM cache 250 can be used as intermediate buffers to store subsets of data stored in main memory 280. The subset of data is typically the most recently accessed data by processing core 220 and can include data acquired from main memory 280 in a data read operation or data to be stored in main memory 280 in a data write operation. Due to temporal and spatial localities, such data are likely going to be accessed by processing core 220 again.

Cache 230 includes a tag array 232 and a data array 234. Data array 234 includes a plurality of data entries 234a each storing data acquired from main memory 280 that was accessed (or will likely be accessed) by processing core 220. Tag array 232 includes a plurality of tag entries 232a respectively corresponding to plurality of data entries 234a in data array 234. Each tag entry 232a stores an address tag and status information of the data in the corresponding data entry 234a.

Similarly, DRAM cache 250 includes a DRAM cache tag array 252 and a DRAM cache data array 254. DRAM cache data array 254 includes a plurality of data entries 254a each storing data to be accessed by processing core 220. DRAM cache tag array 252 includes a plurality of tag entries 232a respectively corresponding to the plurality of data entries 254a in DRAM cache data array 254. Each tag entry 252a in DRAM cache tag array 252 stores an address tag and status information of the data stored in the corresponding data entry 234a.

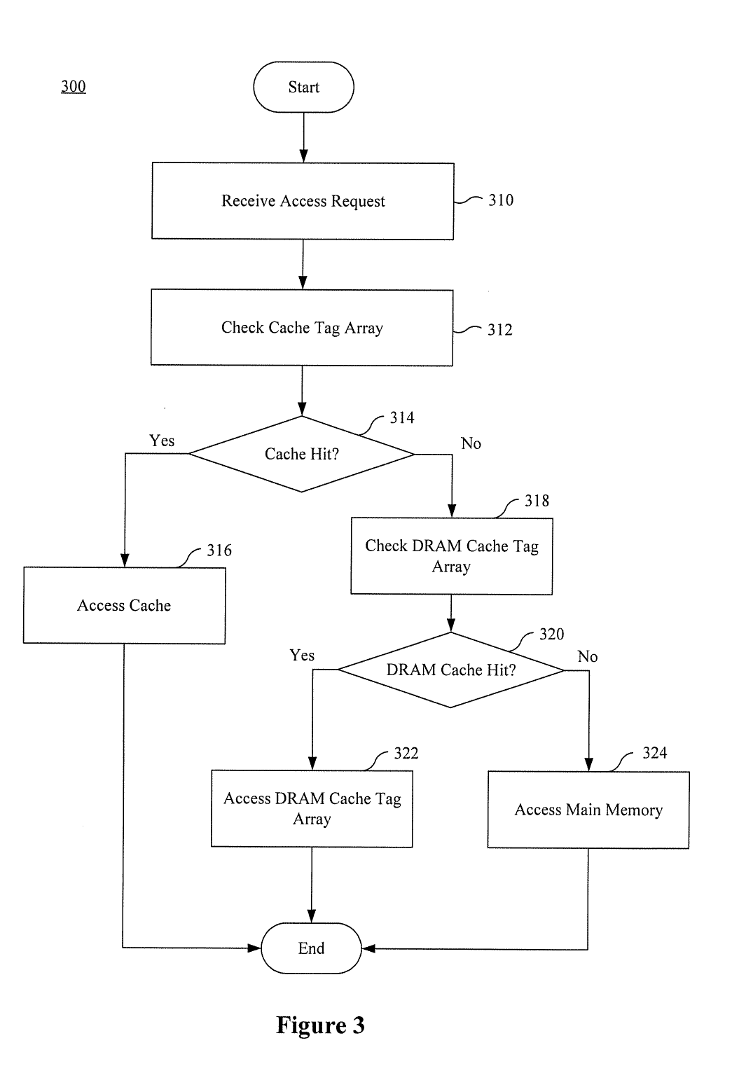

FIG. 3 is flow chart of an exemplary process 300 for memory access in an exemplary processing system (e.g., processing system 200). Process 300 can be performed by processing logic that includes hardware (e.g., circuitry, dedicated logic, programmable logic, microcode, etc.), software (e.g., operations being performed by a functional unit), firmware, or a combination thereof In some embodiments, process 300 is performed by control circuitry of the processing system (e.g., control circuitry 240). Alternatively, some or all of the steps of process 300 may be performed by other components of the processing system.

At step 310, the control circuitry receives an access request issued by processing core 220. The access request can be a read request for reading data from a memory location associated with an address tag, or a write request for writing data to a memory location associated with the address tag. At step 312, the control circuitry checks a cache tag array (e.g., tag array 232) in a cache (e.g., cache 230) that stores address tags and status information, by comparing the address tag included in the access request with the address tags stored in the cache tag array. At step 314, the control circuitry determines whether the access request is a cache hit or a cache miss. A cache hit occurs when the cache stores a valid copy of the requested data, and a cache miss occurs when the cache does not store a valid copy of the requested data. If the request is a cache hit (step 314: Yes), then, at step 316, the control circuitry accesses a cache data array (e.g., data array 234). If the access request is a read request, the control circuitry reads the requested data from the cache data array. If the access request is a write request, the control circuitry writes data to the cache data array. Otherwise, if the access request is a cache miss (step 314: No), then, at step 318, the control circuitry checks a DRAM cache tag array (e.g., DRAM cache tag array 252) by comparing the address tag included in the access request with the address tags stored in the DRAM cache tag array. At step 320, the control circuitry determines whether the access request is a DRAM cache hit or a DRAM cache miss. The DRAM cache hit occurs when the DRAM cache stores a valid copy of the requested data, and the DRAM cache miss occurs when the DRAM cache does not store a valid copy of the requested data. If a DRAM cache hit occurs (step 320: Yes), then, at step 322, the control circuitry accesses a DRAM cache data array (e.g., DRAM cache data array 254) to read data from or write data to the DRAM cache data array. Otherwise, if a DRAM cache miss occurs (step 320: No), then, at step 324, the control circuitry accesses a main memory (e.g., main memory 280) to read data from or write data to the main memory. After completing step 316, 322, or 324, the control circuitry finishes process 300.

With a DRAM cache integrated in either 3D stacking or MCP manner, the latency for the CPU to access the DRAM cache on a DRAM cache die is not trivial. This is because cross-die communication is involved through through-silicon via (e.g., through-silicon vias 116) or MCP links (e.g., MCP links 136). These latencies could be twice or even more expensive than accessing last-level caches (LLC) disposed on the CPU die. If a DRAM cache miss occurs and the DRAM cache is unable to supply the requested data, the CPU has to pull the requested data from a main memory external to the CPU chip, thus the entire data path is significantly lengthened and hurts performance.

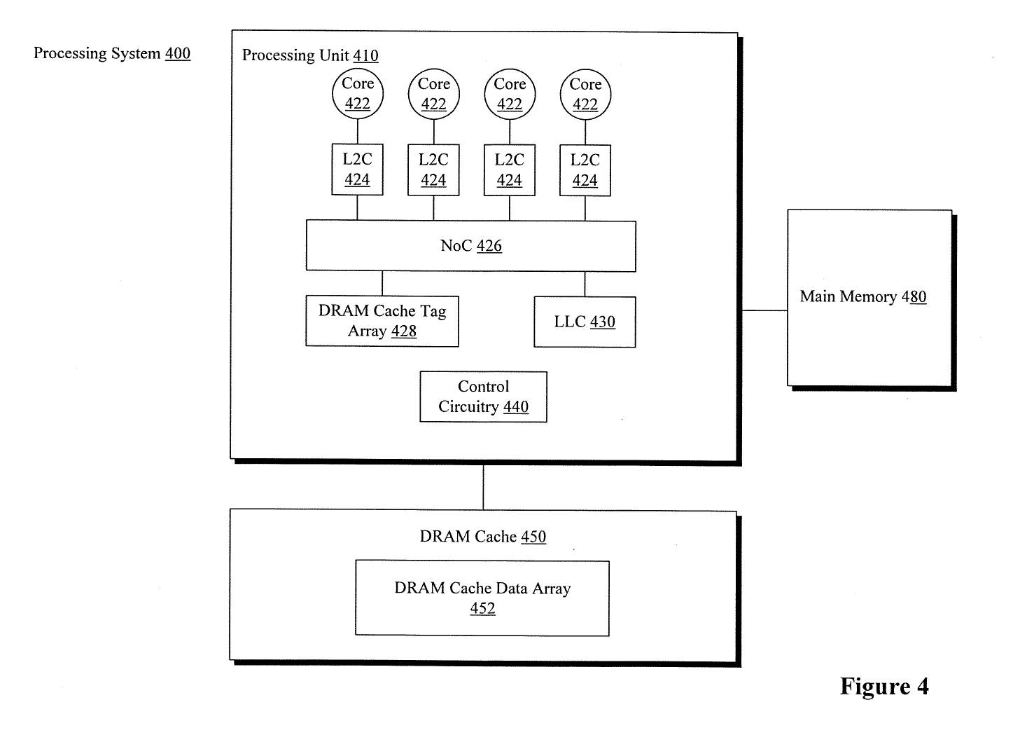

To mitigate the above described issue, the DRAM cache tag array is placed on the CPU die, apart from the DRAM cache data array on the DRAM cache die. FIG. 4 schematically illustrates an exemplary processing system 400 having such configuration. As shown in FIG. 4, processing system 400 includes a processing unit 410, and a DRAM cache 450 coupled to processing unit 410, and a main memory 480 coupled to processing unit 410. Processing unit 410 and DRAM cache 450 can be included in a CPU chip (e.g., CPU chip 110 or 130) in which processing unit 410 is disposed on a CPU die (e.g., CPU die 112 or 132), and DRAM cache 450 is disposed on a DRAM die (e.g., DRAM die 114 or 134) physically separated from the CPU die. Processing unit 410 includes a plurality of processing cores 422, a plurality of Level-2 caches (L2Cs) 424 respectively corresponding to and coupled to the plurality of processing cores 422 and coupled to a Network-on-Chip (NoC) 426. In addition, processing unit 410 includes a DRAM cache tag array 428 and a Last-level cache (LLC) 430 coupled to NoC 426, and control circuitry 440. Main memory 480 can store data to be accessed by processing unit 410. L2Cs 424, LLC 430, and DRAM cache 450 can be used as intermediate buffers to store subsets of data stored in main memory 480. Each one of L2Cs 424 stores a subset of data to be accessed by a corresponding one of processing cores 422. LLC 430 stores a subset of data to be accessed by any one of processing cores 422.

DRAM cache 450 includes a DRAM cache data array 452 that includes a plurality of data entries each storing data to be accessed by processing cores 422. DRAM cache tag array 428 included in processing unit 410 includes a plurality of tag entries respectively corresponding to the plurality of data entries in DRAM cache data array 452. Each tag entry in DRAM cache tag array 428 stores an address tag and status information of the data stored in the corresponding data entry in DRAM cache data array 452. Although not illustrated in FIG. 4, each one of L2Cs 424 and LLC 430 can include a data array that stores data and a tag array that stores address tags and status information of the data stored in the data array.

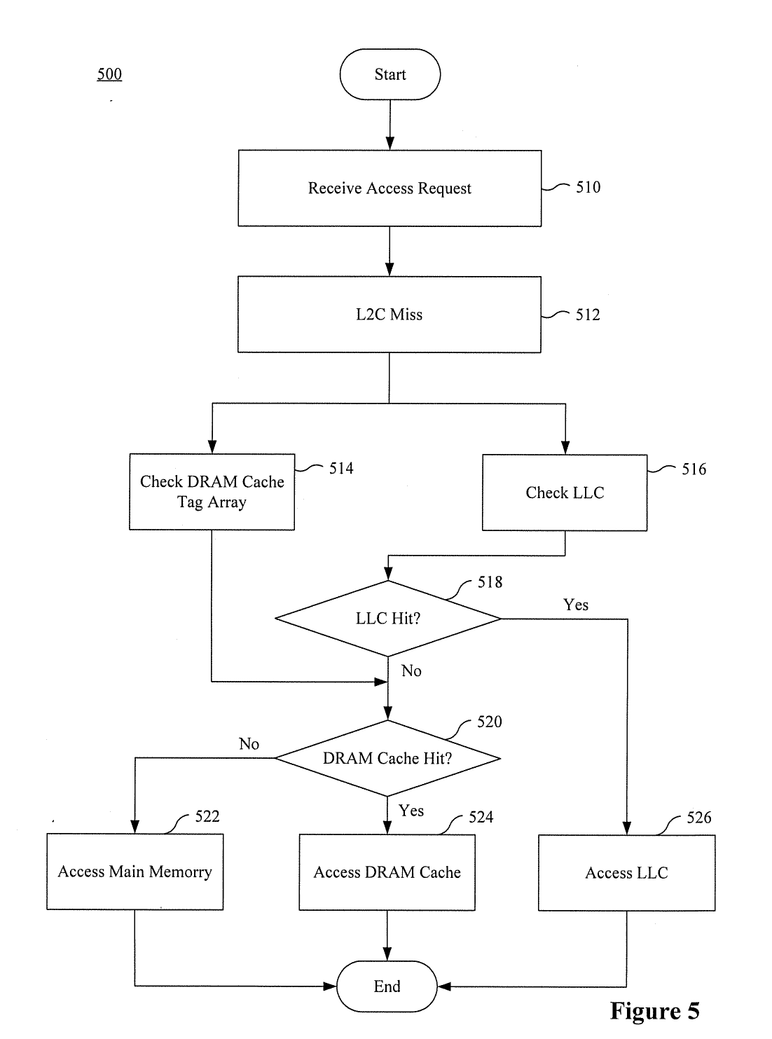

FIG. 5 is flow chart of an exemplary process 500 for memory access in a processing system (e.g., processing system 400). Process 500 can be performed by processing logic that includes hardware (e.g., circuitry, dedicated logic, programmable logic, microcode, etc.), software (e.g., operations being performed by a functional unit), firmware, or a combination thereof. In some embodiments, process 500 is performed by control circuitry of the processing system (e.g., control circuitry 440). Alternatively, some or all of the steps of process 500 may be preformed by other components of an exemplary processing system.

At step 510, the control circuitry receives an access request from one of processing cores 422. The access request can be a read request for reading data from a memory location associated with an address tag, or a write request for writing data to a memory location associated with the address tag. At step 512, the control circuitry determines that the access request is an L2C cache miss. For example, the control circuitry checks the tag array in each one of the L2Cs (e.g., L2C 424) and determines that none of the L2Cs stores a valid copy of the requested data. At step 514, the control circuitry checks the DRAM cache tag array (e.g., DRAM cache tag array 428), by comparing the address tag included in the access request with the address tags stored in the DRAM cache tag array. Simultaneously, at step 516, the control circuitry checks an LLC tag array in an LLC (e.g., LLC 430), by comparing the address tag included in the access request with the address tags stored in the LLC tag array. In other words, the DRAM cache tag array is checked (step 514) in concurrent with the checking of the LLC tag array (step 516).

At step 518, the control circuitry determines whether the access request is an LLC hit or an LLC miss. The LLC hit occurs when the LLC stores a valid copy of the requested data, and the LLC miss occurs when the LLC does not store a valid copy of the requested data. If the access request is an LLC hit (step 518: Yes), then, at step 526, the control circuitry accesses the LLC to read data from or write data to the LLC.

If the access request is an LLC miss (step 518: No), then, at step 520, the control circuitry determines whether the access request is a DRAM cache hit or a DRAM cache miss. The DRAM cache hit occurs when the DRAM cache stores a valid copy of the requested data, and the DRAM cache miss occurs when the DRAM cache does not store a valid copy of the requested data. If the access request is a DRAM cache hit (step 520: Yes), then, at step 524, the control circuitry accesses the DRAM cache to read data from or write data to the DRAM cache. If the access request is a DRAM cache miss (step 520: No), then, at step 522, the control circuitry accesses a main memory (e.g., main memory 480) to read data from or write data to the main memory. After completing step 522, 524, or 526, the control circuitry finishes process 500.

In process 500, the DRAM cache array is checked (step 514) in concurrent with the checking of the LLC tag array (step 516). Therefore, by the time an LLC miss is detected, the control circuitry already knows whether the DRAM cache has a copy of the requested data or not, and only needs to access the DRAM cache in a DRAM cache die when a DRAM hit is detected. However, placing the DRAM cache tag array on the CPU die consumes valuable space of the LLC. With the regular 64 byte cache line size, a 256 MB DRAM cache would require over 11 MB of tag space, which is roughly ¼ of the size of a LLC. The cache line refers to the granularity of a cache, i.e., the smallest unit of data in a cache. One way to reduce the tag space overhead is to enlarge the cache line size. Increasing the cache line size to 4 KB would reduce the tag space overhead of the 256 MB DRAM cache to only 100 KB. However, having larger cache lines implies that when a DRAM cache miss occurs, the control circuitry would have to fetch a larger amount of data from the main memory in order to fill the larger cache line, which would easily saturate the memory bandwidth. Due to these limitations, commercial CPU vendors have only been using DRAM caches formed on the same die with the CPU that only require software intervention, but never used DRAM caches as hardware-managed caches that are transparent to software.

In the disclosed embodiments, a software hardware codesign approach is provided to address the design issue that DRAM caches face. Considering the tag array storage overhead that consumes precious LLC space when cache line size is small, in the disclosed embodiments, a large DRAM cache line (e.g., 4 KB) is used to replace the traditional 64 B cache line. As discussed earlier, with larger cache line sizes, cache misses becomes more expensive without careful control, because memory bandwidth can be easily saturated. For example, a cache miss requires 4 KB data to be fetched from the main memory, which is equivalent to 64 reads from the main memory. In the disclosed embodiments, instead of letting the DRAM go out of control, only a region of data is allowed to be stored in the DRAM cache in accordance with a predefined Service Level Agreement (SLA). An SLA is a contract established between a service provider and an end user that defines the level of service the service provider provides and must abide. The SLA is a prevalent criteria used in cloud computing. This allows important applications defined in the SLA to enjoy the performance benefit that DRAM cache provides, and reduces the aggregated memory traffic since less DRAM cache accesses and hence less misses are produced.

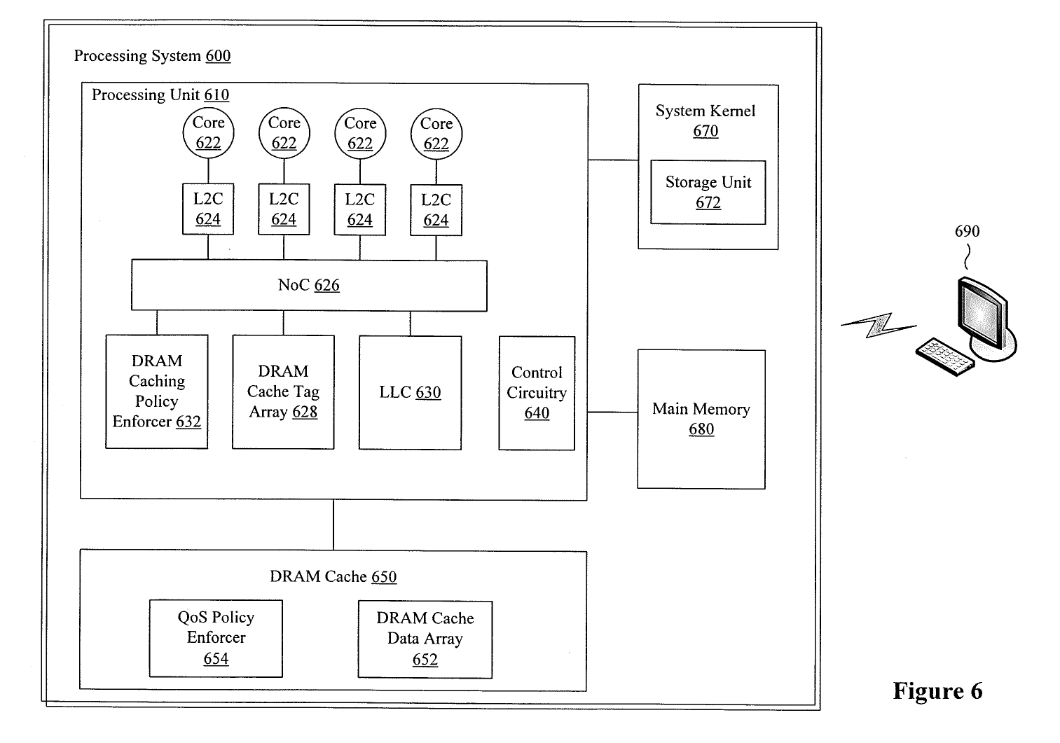

FIG. 6 schematically illustrates a processing system 600, consistent with the disclosed embodiments. Processing system 600 can be included in a cloud-based server of a service provider. The server can be accessed by a user device 690 via a network.

As shown in FIG. 6, processing system 600 includes a processing unit 610, and a DRAM cache 650, a system kernel 670, and a main memory 680 coupled to processing unit 610. Main memory 680 can store data to be accessed by processing unit 610. System kernel 670 can control the operation of processing system 600. System kernel 670 includes a storage unit 672 that stores a task_struct data structure that describes attributes of one or more tasks/threads to be executed on processing system 600.

Processing unit 610 and DRAM cache 650 can be included in a CPU chip (e.g., CPU chip 110 or 130) in which processing unit 610 is disposed on a CPU die (e.g., CPU die 112 or 132) and DRAM cache 650 is disposed on a DRAM die (e.g., DRAM die 114 or 134) physically separated from the CPU die. Processing unit 610 includes a plurality of processing cores 622, a plurality of Level-2 caches (L2Cs) 624 respectively corresponding to and coupled to the plurality of processing cores 622 and coupled to a Network-on-Chip (NoC) 626. In addition, processing unit 610 includes a DRAM cache tag array 628, a Last-level cache (LLC) 630, and a DRAM caching policy enforcer 632 coupled to NoC 626, and control circuitry 640. DRAM cache 650 includes a DRAM cache data array 652 and a QoS policy enforcer 654. Processing cores 622, L2Cs 624, DRAM cache tag array 628, LLC 630, control circuitry 640, DRAM cache 650, and DRAM cache data array 652 are substantially the same as processing cores 422, L2Cs 424, DRAM cache tag array 428, LLC 430, control circuitry 440, DRAM cache 450, and DRAM cache data array 452 in FIG. 4. Therefore, detailed descriptions of these components are not repeated. DRAM caching policy enforcer 632 controls access to DRAM cache 650, and detailed description thereof will be provided in more detail below.

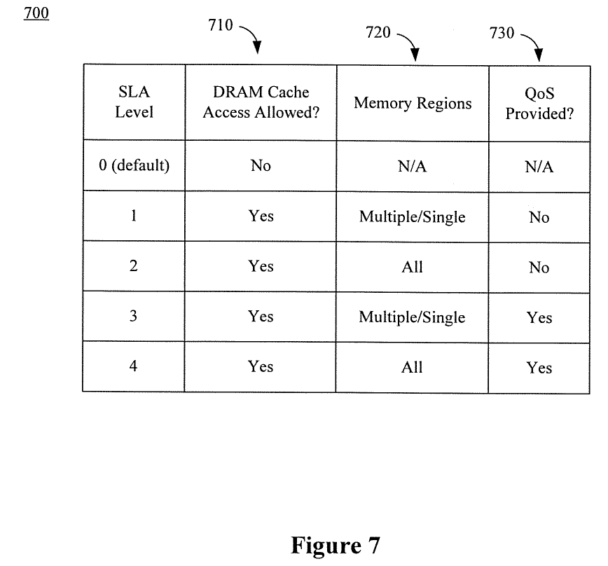

FIG. 7 illustrates an exemplary Table 700 defining several levels of SLA provided by a service provider to a user who sends tasks/threads to the service provider. The service provider has a processing system (e.g., processing system 600) equipped with a DRAM cache (e.g., DRAM cache 650) coupled to a processing unit (e.g., processing unit 610). In a public cloud environment, a higher SLA level implies more expensive service provided by the service provider. Similarly, in a private cloud or internal data center environment, highest SLA level is usually granted to tasks of high importance and user-facing online tasks.

According to column 710 of table 700, the SLA level associated with a user who issues a task/thread can define whether the task/thread is allowed to access the DRAM cache. By default, i.e., at SLA level 0, no tasks are allowed to store their data in the DRAM cache. In other words, a task issued by a user with SLA level 0 cannot access the DRAM cache. At higher SLA levels (e.g., SLA levels 1-4), DRAM cache accesses are allowed. In other words, a task issued by a user with any one of SLA levels 1-4 can access the DRAM cache, i.e., is DRAM cacheable.

According to column 720 of table 700, the SLA level can also define the amount of memory regions of a task/thread that are allowed to access the DRAM cache, i.e., whether a processing core that executes the task/thread can read data from or write data to the DRAM cache. The amount of virtual memory to be consumed by a task can be further divided into virtual memory regions. A virtual memory region can be defined as a fixed size of virtual memory (e.g., 1 MB), which can be both consistent and inconsistent in physical space. While SLA level 2 allows a task's entire memory region to be stored in the DRAM cache, SLA level 1 only allows a single memory region or multiple memory regions of the task to be stored in the DRAM cache. In some embodiments, the amount of memory regions that are DRAM cacheable can be defined at even finer granularity, which then corresponds to more SLA levels.

According to column 730 of table 700, in addition to the amount of memory regions allowed, the SLA level can further define whether Quality of Service (QoS) is provided. If QoS is provided, then the amount of DRAM cache occupancy of a task is guaranteed. For example, a QoS policy enforcer (e.g., QoS policy enforcer 645) can be configured to ensure that the memory regions that are DRAM cacheable can actually access the DRAM cache. If QoS is not provided, then the amount of DRAM cache occupancy of a task cannot be guaranteed. This in turn defines SLA level 3 and 4 in table 700. The key differentiation between SLA level 1 and SLA level 3, or between SLA level 2 and SLA level 4 is whether the amount of DRAM cache occupancy of a task is guaranteed.

Further description regarding how the SLA-based DRAM caching control affects thread allocation, thread execution, and context switches respectively.

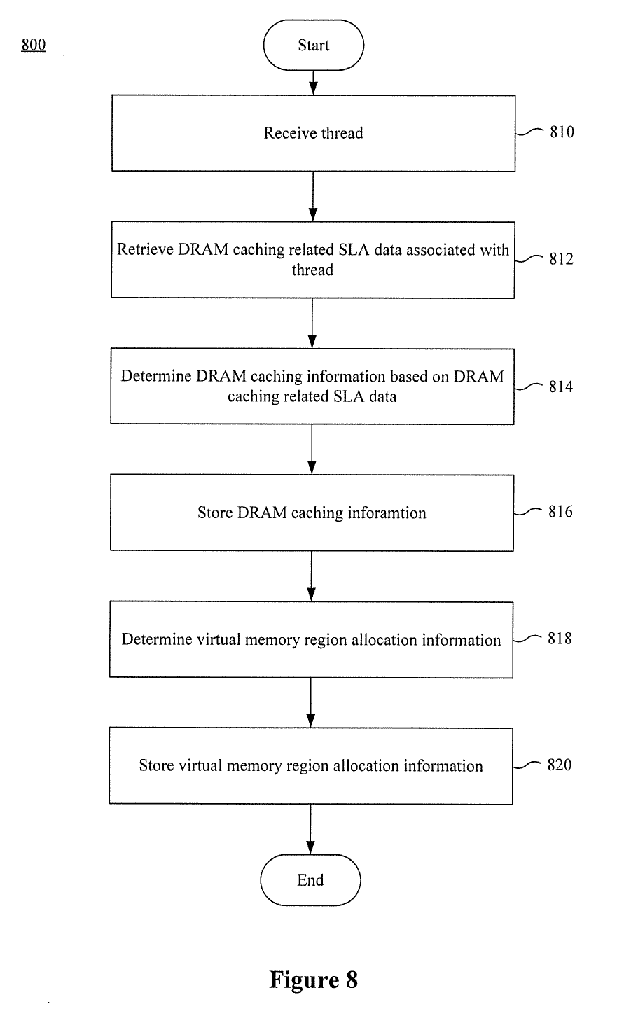

FIG. 8 is a flow chart of an exemplary process 800 for thread allocation in an exemplary processing system (e.g., processing system 600) of a cloud-based server of a service provider, consistent with the disclosed embodiments. The server is disposed in a cloud computing environment. Process 800 can be performed by processing logic that includes hardware (e.g., circuitry, dedicated logic, programmable logic, microcode, etc.), software (e.g., operations being performed by a functional unit), firmware, or a combination thereof included in processing system 600.

At step 810, the processing system receives a thread to be executed on the processing system. The thread can be issued by a user device (e.g., user device 690). At step 812, a task scheduler in the cloud computing environment can retrieve DRAM caching related SLA data associated with the thread. The DRAM caching related SLA data can be related to a SLA level established between the service provider and the user of the user device. The task scheduler then transfers the thread and the DRAM caching related SLA data associated with the thread to a system kernel (e.g., system kernel 670).

At step 814, the system kernel determines DRAM caching information based on the DRAM caching related SLA data. The DRAM caching information can include information indicating whether the thread is allowed to access the DRAM cache, how many virtual memory regions of the thread are allowed to access the DRAM cache, and/or whether QoS is provided (QoS) while the thread is being executed.

At step 816, the system kernel stores the DRAM caching information in a storage unit (e.g., storage unit 672) that stores a task_struct data structure that describes the attribute of the thread. For example, the information indicating whether the thread is allowed to access the DRAM cache can be stored as a DRAM_Cacheable bit associated with the thread. The information indicating how many virtual memory regions of the thread are allowed to access the DRAM cache can be stored as one or more Region bits associated with the thread. The information indicating whether QoS is provided can be stored as a QoS bit associated with the thread.

If the DRAM caching information indicates that only a part of the virtual memory regions to be consumed by the thread is allowed to access the DRAM cache, then, at step 818, the system kernel determines virtual memory region allocation information that defines which virtual memory regions or pages are allowed to access the DRAM cache. In some embodiments, the system kernel can delegate the thread itself to select which pages or virtual memory regions are allowed to access the DRAM cache. For example, the system kernel can issue an mprotect system call to the thread such that the thread itself can determine which pages or virtual memory regions are allowed to access the DRAM cache. The thread can select data areas (e.g., pages, virtual memory regions) that are more frequently accessed by a processing unit to be DRAM cache accessible.

At step 820, the system kernel stores the virtual memory region allocation information in the storage unit. For example, the system kernel can write a dedicated bit (e.g., PTE_DRAM_Cacheable) in an attribute segment of a Page Table Entry (PTE) corresponding to each one of the pages that are allowed to access the DRAM cache. The PTE can be included in the task_struct data structure stored in the storage unit of the system kernel. After completing step 820, the processing system finishes process 800.

When the DRAM caching information indicates that all of the memory regions to be consumed by the thread are allowed to access the DRAM cache (e.g., SLA level 2 or 4), the system kernel does not need to allocate the virtual memory regions for accessing the DRAM cache and does not use the PTE DRAM bit to mark any page. Therefore, steps 818 and 820 can be omitted for threads issued by users having that level of privilege.

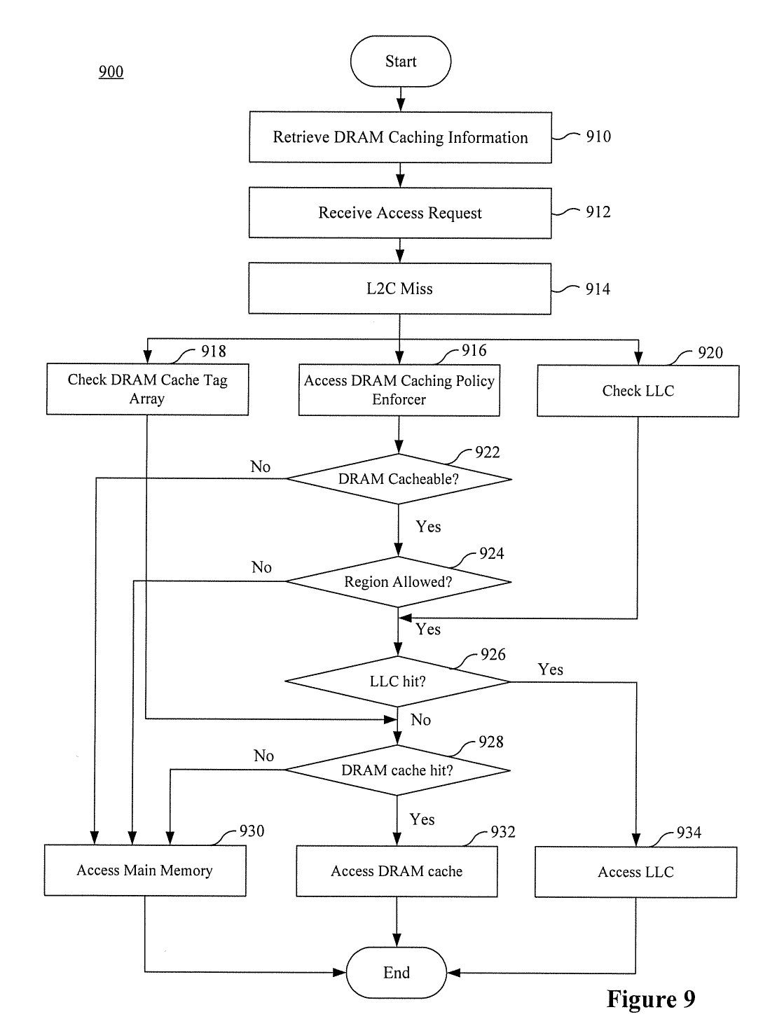

FIG. 9 is a flow chart of an exemplary process 900 for thread execution in an exemplary processing system (e.g., processing system 600), consistent with the disclosed embodiments. Process 900 can be performed after performing process 800. Process 900 can be performed by processing logic that includes hardware (e.g., circuitry, dedicated logic, programmable logic, microcode, etc.), software (e.g., operations being performed by a functional unit), firmware, or a combination thereof included in processing system 600.

At step 910, before a thread is about to start execution on a processing core (e.g., one of processing cores 622) in the processing system, the processing system retrieves the DRAM caching information associated with the thread. For example, a kernel scheduler in the processing system reads out the DRAM caching information, <DRAM_Cacheable, Region, QoS>, from the task_struct data structure associated with the thread and stored in the storage unit of the system kernel. The kernel scheduler writes the DRAM_Cacheable and Region bits into a control register (CR) of the processing core that is going to execute the thread, and writes the QoS bit into a machine status register (MSR) of the processing core.

At step 912, when a thread starts to be executed on the processing core, control circuitry of the processing unit (e.g., control circuitry 640) receives an access request from the processing core. The access request can be a read request for reading data from a memory location associated with an address tag, or a write request for writing data to a memory location associated with the address tag. At step 914, the control circuitry determines that the access request is an L2C cache miss. For example, the control circuitry checks the tag array in an L2C (e.g., one of L2Cs 624) that corresponds to the processing core and determines that the L2C does not store a valid copy of the requested data.

At step 916, the control circuitry inquires a DRAM caching policy enforcer (e.g., DRAM caching policy enforcer 632) to check whether the currently running thread is DRAM cacheable, i.e., whether the thread is allowed to access the DRAM cache. For example, the DRAM caching policy enforcer examines a CR.DRAM_Cacheable bit associated with the currently running thread. Simultaneously, at step 918, the control circuitry checks the DRAM cache tag array (e.g., DRAM cache tag array 628), by comparing the address tag included in the access request with the address tags stored in the DRAM cache tag array. Still simultaneously, at step 920, the control circuitry checks an LLC tag array included in an LLC (e.g., LLC 630), by comparing the address tag included in the access request with the address tags stored in the LLC tag array. In other words, the DRAM caching policy enforcer is accessed (step 916) in concurrent with the LLC access (step 920) and DRAM cache tag array access (step 918).

At step 922, the control circuitry determines whether the currently running thread is allowed to access the DRAM cache, i.e., DRAM cacheable. The control circuit can determine whether the currently running thread is DRAM cacheable based on the CR.DRAM_Cacheable bit associated with the current running thread, which is checked by DRAM caching policy enforcer at step 916.

If the currently running thread is not allowed to access the DRAM cache (step 922: No), then the control circuitry proceeds to step 930 to access a main memory (e.g., main memory 680) to read the requested data from or write the requested data to the main memory. If the currently running thread is allowed to access the DRAM cache (step 922: Yes), then the control circuitry proceeds to step 924 to determine whether the access request is related to a virtual memory region that is allowed to access the DRAM cache. For example, the DRAM caching policy enforcer examines the result of CR.Region|PTE.DRAM_Cacheable to determine whether the requested data is in a virtual memory region that is allowed to access the DRAM cache. PTE.DRAM_Cacheable is a cached copy of a PTE and is supplied from a Translation Lookaside Buffer (TLB) in the processing unit.

If the access request is related to a virtual memory region that is not allowed to access the DRAM cache (step 924: No), then the control circuitry proceeds to step 930 to access the main memory to read the requested data from or write the requested data to the main memory. If the access request is related to a virtual memory region that is allowed to access the DRAM cache (step 924: Yes), then the control circuit proceeds to step 926 to determine whether the access request is an LLC hit or an LLC miss, which can be based on a result of checking the LLC tag array included in the LLC in step 920. An LLC hit occurs when the LLC stores a valid copy of the requested data, and an LLC miss occurs when the LLC does not store a valid copy of the requested data.

If the access request is an LLC hit (step 926: Yes), then the control circuitry proceeds to step 934 to access the LLC to read the requested data from or write the requested data to the LLC. If the access request is an LLC miss (step 926: No), then the control circuitry proceeds to step 928 to determine whether the access request is a DRAM cache hit, which can be based on a result of checking the DRAM cache tag array in step 918. A DRAM cache hit occurs when the DRAM cache stores a valid copy of the requested data, and a DRAM cache miss occurs when the DRAM cache does not store a valid copy of the requested data.

If the access request is a DRAM cache hit (step 928: Yes), then the control circuitry proceeds to step 932 to access the DRAM cache to read the requested data from or write the requested data to the DRAM cache. If the access request is a DRAM cache miss (step 928: No), then the control circuitry proceeds to step 930 to access the main memory (e.g., main memory 480) to read the requested data from or write the requested data to the main memory. After completing step 930, 932, or 934, the control circuitry finishes process 900.

Moreover, SLA-based DRAM caching control can also affect context switches. When a context switch occurs, that is, when the processing system is about to execute a new thread, the kernel scheduler writes back <DRAM_Cacheable, Region, QoS> of the old thread to the task_struct data structure in the storage unit, and loads <<DRAM_Cacheable, Region, QoS> associated the new thread from the task_struct data structure in memory. The kernel scheduler then writes this information to the CR and MSR of the processing core that is going to execute the new thread.

With the system and methods described in the disclosed embodiments, DRAM cache usage is granted to threads that satisfy SLA requirement, allowing SLA defined high importance tasks to enjoy the benefit of DRAM cache, while still ensuring the sustainable memory bandwidth is not exceeded.

Contemporary CPUs use embedded DRAM as near memory, which provides faster access when compared to main memory. Using DRAM as near memory can require a significant amount of software intervention. This is because the nature of memory requires data allocated in it to use consecutive physical addresses. In practice, it is not easy for applications running on the CPU to allocate large consecutive physical memory or to access data from these locations during data allocation/deallocation. In contrast, the disclosed embodiments use DRAM memory as hardware-managed caches that are software transparent. DRAM cache design cost is mitigated through restricting DRAM cache usage to SLA defined applications.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

1. A computer system of a service provider, comprising:
a processing unit executing a thread issued by a user; and
a random access memory (RAM) cache disposed external to the processing unit and operatively coupled to the processing unit to store data accessed or to be accessed by the processing unit;
wherein the processing unit comprises control circuitry configured to, in response to receiving an access request while the thread is being executed:
determine whether the thread is allowed to access the RAM cache according to a service level agreement (SLA) level established between the service provider and the user; and
when the thread is RAM cacheable, access the RAM cache.

2. The computing system of claim 1, wherein the control circuitry is further configured to:
determine whether the access request is related to a virtual memory region that is allowed to access the RAM cache; and
when the access request is related to a virtual memory region that is allowed to access the RAM cache, access the RAM cache.

3. The computing system of claim 1, wherein the processing unit further comprises a register configured to store caching information associated with the thread,
the caching information including:
whether the thread is allowed to access the RAM cache,
whether a virtual memory region of the thread is allowed to access the RAM cache, and
whether Quality of Service will be provided to the thread.

4. The computer system of claim 1, further comprising:
a system kernel operatively coupled to the processing unit, and configured to, in response to receiving the thread issued by the user:
retrieve the SLA level established between the service provider and the user;
determine caching information based on the SLA level;
store the caching information in a storage unit.

5. The computer system of claim 4, wherein the caching information determined by the system kernel includes:
whether the thread is allowed to access the RAM cache,
whether a virtual memory region of the thread is allowed to access the RAM cache, and
whether Quality of Service will be provided while the thread is being executed.

6. The computer system of claim 4, wherein the system kernel is configured to:
determine, based on the SLA level established between the service provider and the user, a number of memory regions that are allowed to access the RAM cache;
select, based on the number, at least one memory region from a plurality of memory regions to be consumed by the thread to be RAM cacheable; and
store the result of selection in a storage unit.

7. The computer system of claim 1, wherein the RAM cache is a dynamic random access memory (DRAM) cache.

8. The computer system of claim 1, wherein the processing unit comprises a RAM cache tag array configured to store one or more address tags associated with the data stored in the RAM cache.

9. The computer system of claim 8, wherein the control circuitry is configured to, in concurrent with determining whether the thread is RAM cacheable:
check the RAM cache tag array to determine whether the access request is a RAM cache hit or a RAM cache miss; and
check a last level cache (LLC) of the processing unit to determine whether the access request is an LLC hit or an LLC miss.

10. The computer system of claim 1, wherein the processing unit includes a plurality of processing cores.

11. A method for operating a system kernel in a computer system of a service provider, the computer system including a processing unit and a random access memory (RAM) cache external to the processing unit and operatively coupled to the processing unit, the method comprising:
receiving a thread issued by a user;
retrieving a service level agreement (SLA) level established between the service provider and the user; and
determining, based on the SLA level, whether the thread is allowed to assess the RAM cache.

12. The method of claim 11, further comprising:
determining, based on the SLA level, a number of memory regions that are allowed to access the RAM cache;
selecting, based on the number, at least one memory region from a plurality of memory regions to be consumed by the thread to be RAM cacheable.

13. The method of claim 11, further comprising:
determining, based on the SLA level established between the service provider and the user, whether Quality of Service will be provided while the thread is being executed.

14. The method of claim 11, wherein the RAM cache is a dynamic random access memory (DRAM) cache.

15. A method for operating a processing unit in a computer system of a service provider, the computer system including a random access memory (RAM) cache external to the processing unit and operatively coupled to the processing unit, the method comprising:
receiving an access request while a thread issued by a user is being executed;
determining whether the thread is allowed to access the RAM cache according to a service level agreement (SLA) level established between the service provider and the user; and
when the thread is RAM cacheable, accessing the RAM cache.

16. The method of claim 15, further comprising:
determining whether the access request is related to a virtual memory region that is allowed to access the RAM cache; and
when the access request is related to a virtual memory region that is allowed to access the RAM cache, accessing the RAM cache.

17. The method of claim 15, further comprising, in concurrent with determining the thread is RAM cacheable:
checking a RAM cache tag array included in the processing unit to determine whether the access request is a RAM cache hit or a RAM cache miss; and
check a last level cache (LLC) of the processing unit to determine whether the access request is an LLC hit or an LLC miss.

18. The method of claim 17, further comprising, when the access request is an LLC miss and a RAM cache hit, accessing the RAM cache.

19. The method of claim 17, further comprising, when the access request is an LLC miss and a RAM cache miss, accessing a main memory coupled to the processing unit.

20. The method of claim 15, wherein the RAM cache is a dynamic random access memory (DRAM) cache.

21. A computing device, comprising:
a processing unit;
a random access memory (RAM) cache disposed external to the processing unit and operatively coupled to the processing unit, the RAM cache includes a cache data unit storing data accessed or to be accessed by the processing unit;
wherein the processing unit includes a cache tag unit storing address tags associated with the data stored in the cache data unit in the RAM cache.

22. A processing unit, comprising:
a cache tag unit storing address tags associated with data accessed or to be accessed by the processing unit,
wherein the data accessed or to be accessed by the processing unit is stored in a random access memory (RAM) cache disposed external to the processing unit.

23. A method for operating a processing unit in a computer system of a service provider, the computer system including a random access memory (RAM) cache external to the processing unit and operatively coupled to the processing unit, the method comprising:
receiving an access request while a thread issued by a user is being executed;
determining whether the access request is a RAM cache hit by checking a cache tag unit included in the processing unit; and
when the access request is a RAM cache hit, accessing the RAM cache to access data.
